(19) United States
(12) Patent Application Publication
(10) Pub. No.: US 2017/0037646 A1
(43) Pub. Date: Feb. 9, 2017

(54) TEMPLATE MOLD SEVERING SCREW BAR

(71) Applicant: HENG-MAO LIN, Kaohsiung (TW)

(72) Inventors: JUI-CHUNG HUANG, Kaohsiung (TW); SHENG-PAO WU, Kaohsiung (TW)

(21) Appl. No.: 15/226,097

(22) Filed: Aug. 2, 2016

(30) Foreign Application Priority Data
Aug. 4, 2015 (TW) 104212502

(51) Int. Cl. E04G 17/04; E04G 19/00; F16B 25/10; E04G 17/06

(52) U.S. Cl. CPC E04G 17/042; E04G 17/06; E04G 17/047; E04G 19/003; F16B 25/10

(57) ABSTRACT

A template mold severing screw bar used on template construction work comprises a self-tapping screw bar which includes a thread portion formed annularly on the circumference, a transmission end and a tapping end at another end opposite to the transmission end, and at least one anchor member screwed on the thread portion of the self-tapping screw bar. The anchor member includes a screwing portion and a leaning portion anchored on one end of the screwing portion. The screwing portion includes a screw hole which can be screwed by the thread portion. The leaning portion includes a friction end to firmly mount onto a template without slipping to reduce impact during concrete filling between two opposing templates, thus can enhance bulging resistance and facilitate fast assembly with fewer components and without requiring too many complex processes.

### FIELD OF THE INVENTION

The present invention relates to a template mold severing screw bar and particularly to a screw bar structure collaborated with anchor members in construction to function as external support of templates that also can be easily assembled on the templates to facilitate erection of the templates.

### BACKGROUND OF THE INVENTION

In the construction filling work of the conventional reinforced concrete structure templates are generally being used. To build the templates, please referring to FIG. 1, first, two corresponding templates 13 have to be erected and spaced from each other at a preset distance; next, drill an aperture on each template 13 through a drill machine (not shown in the drawing) corresponding to each other to allow a screw bar 1 to run through the two templates 13 via the apertures; then dispose a gasket 11 at each of two ends of the screw bar 1; finally fasten a nut 12 on each end of the screw bar 1 outside the gasket 11 to securely position the screw bar 1 on the two templates 13 so that concrete filling work can be proceeded thereafter. Since the screw bar 1 has to be coupled with the gaskets 11 at two ends and screwed by the nuts 12 thereafter, the construction work is burdened with more complicated processes. As a result, construction of the templates becomes more troublesome and time-consuming.

Moreover, after assembly is finished, in the later concrete filling operation a great pressure usually takes place that could cause dislocation of the templates 13 due to inadequate friction force of the gaskets 11 at the anchor positions. This could impact the quality of the entire construction project. In addition, dislocation of the templates 13 could cause deviation of the finished profile of the concrete that requires redoing or extra adorning, and also results in waste of material.

How to provide improvements to remedy the shortcomings of troublesome and time-consuming process of the conventional template construction and provide speedy assembly to save time and achieve more secure structure is an issue remained to be resolved in the industry.

### SUMMARY OF THE INVENTION

The primary object of the present invention is to provide a template mold severing screw bar that provides external support forces for templates and also can be assembled simply.

To achieve the foregoing object the present invention provides a template mold severing screw bar for building of construction templates. The template mold severing screw bar comprises:

a self-tapping screw bar which includes a thread portion formed annularly on the circumference, a transmission end and a tapping end at another end opposite to the transmission end. The tapping end includes an edge portion and a shred exit portion. The edge portion is located at lateral sides of the tapping end. The shred exit portion is located at one side abutting the edge portion. The self-tapping screw bar further includes a stem shrunk portion between the tapping end and the thread portion; and

at least one anchor member screwed on the thread portion of the self-tapping screw bar. The anchor member includes a screwing portion and a leaning portion anchored on one end of the screwing portion. The screwing portion includes a screw hole which can be screwed by the thread portion. The screw hole includes at least one trench run through a first end surface of one side of the anchor member and a second end surface of another side thereof, or run through by incorporating with the tapping end. The leaning portion comprises an aperture communicating with the screw hole, and is formed in a non-plane fashion, and includes a friction end at one end remote from the screwing portion.

The invention thus formed can provide features as follow:

1. The self-tapping screw bar and the anchor member can be formed in an integrated structure and can be assembled quickly by users without requiring complex process and assembly elements, hence can improve user operation and efficiency in work.

2. The anchor member provides improved steadiness. The friction end formed thereon can mounted onto the template firmer without slipping, hence can reduce impact during concrete filling between the templates and enhance bulging-resistant force.

3. The invention also can provide temporary reinforced function quickly in the event of incidental collapse of the templates during concrete filling to avoid operation suspension after template collapse has taken place.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional technique in a use condition.

FIG. 2 is an exploded view of the invention.

FIG. 3 is a schematic view of the invention showing a use condition before drilling.

FIG. 4 is a schematic view of the invention showing a use condition during drilling.

FIG. 5 is a schematic view of the invention showing a use condition.

FIG. 6A is a plane view of a transmission end formed in a triangular strut.

FIG. 6B is a plane view of a transmission end formed in a quadrangle strut.

FIG. 6C is a plane view of a transmission end formed in a pentagonal strut.

FIG. 6D is a plane view of a transmission end formed in a hexagonal strut.

FIG. 6E is a plane view of a transmission end formed in a heptagonal strut.

FIG. 6F is a plane view of a transmission end formed in an octagonal strut.

FIG. 6G is a plane view of a transmission end formed in a nonagonal strut.

FIG. 6H is a plane view of a transmission end formed in a decagonal strut.

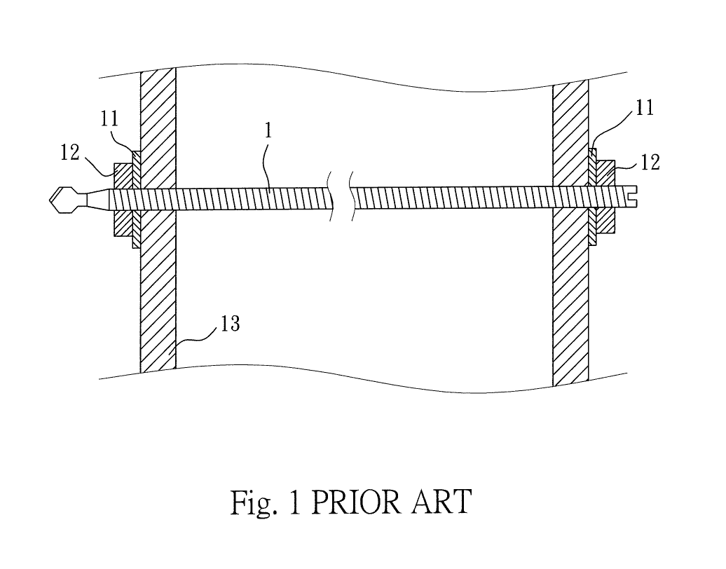

### DETAILED DESCRIPTION OF THE PREFERRED EMBODIMENTS

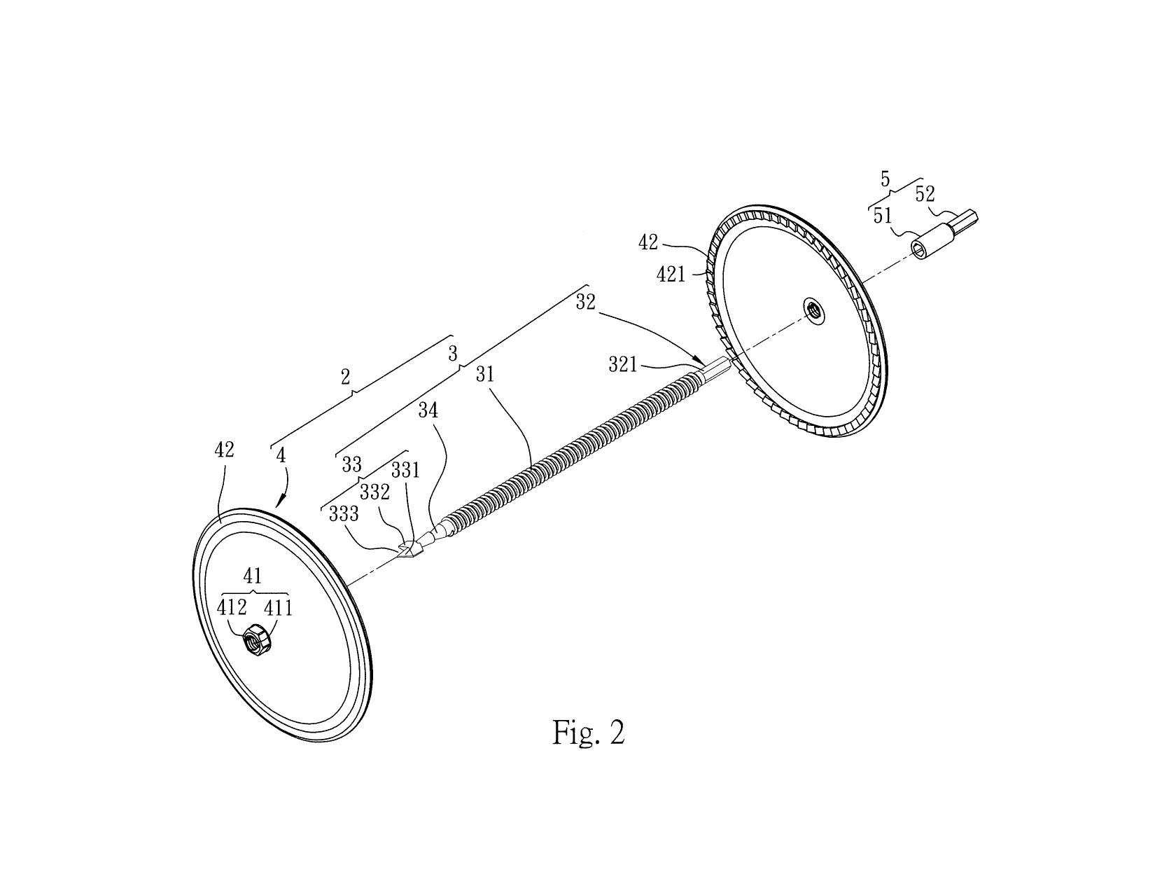

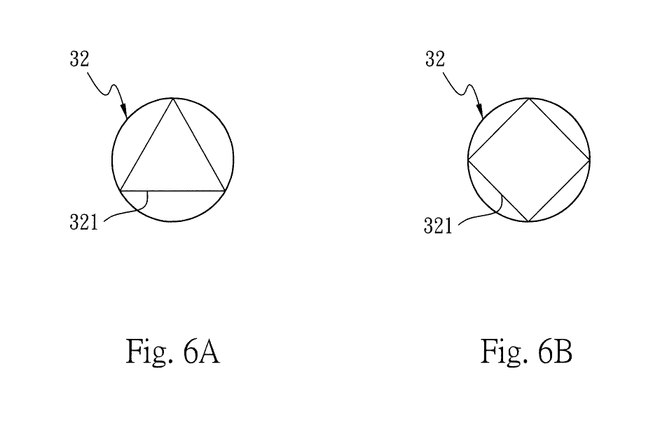

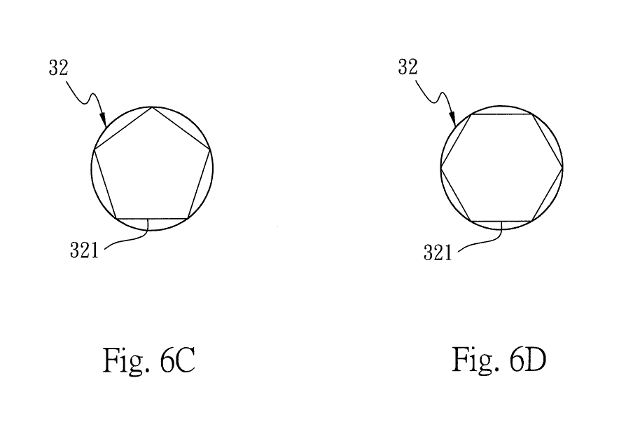

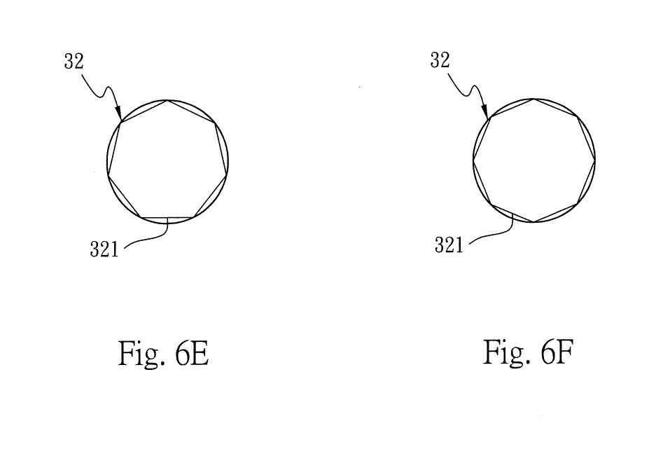

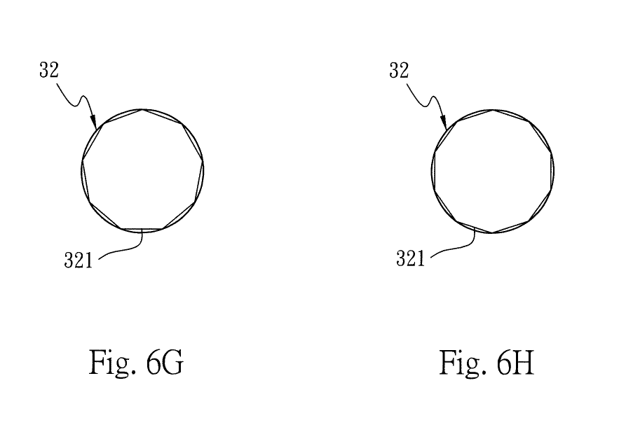

The present invention aims to provide a template mold severing screw bar 2 used on template construction work. The template mold severing screw bar 2 comprises a self-tapping screw bar 3 and at least one anchor member 4. First, please refer to FIG. 2 for related structure of the template mold severing screw bar 2. The self-tapping screw bar 3 includes a thread portion 31 formed annularly on the circumference thereof, and a transmission end 32 and a tapping end 33 at another end opposite to the transmission end 32. The tapping end 33 includes an edge portion 331 and a shred exit portion 332. The edge portion 331 is located at lateral sides of the tapping end 33. The shred exit portion 332 is located at one side abutting the edge portion 331. The tapping end 33 is formed at a diameter greater than that of the thread portion 31. The transmission end 32 is a polygonal strut 321 and can be, as shown from FIG. 6A through 6H, a triangular strut, a quadrangle strut, a pentagonal strut, a hexagonal strut, a heptagonal strut, an octagonal strut, a nonagonal strut or a decagonal strut. Please also referring to FIG. 2, the self-tapping screw bar 3 further includes a stem shrunk portion 34 between the tapping end 33 and the thread portion 31; and

The anchor member 4 is screwed on the thread portion 31 of the self-tapping screw bar 3, and includes a screwing portion 41 and a leaning portion 42 anchored on one end of the screwing portion 41. The screwing portion 41 includes a screw hole 411 which can be screwed by the thread portion 31. The leaning portion 42 includes an aperture communicating with the screw hole 411. The screw hole 411 further includes at least one trench 412 run through the end surface of one side of the anchor member 4 and the end surface of another side thereof, or run through by incorporating with the tapping end 33. The leaning portion 42 is formed in a non-plane fashion, and includes a friction end 421 at one end remote from the screwing portion 41. The friction end 421 is formed in at least a semi-sphere, a sphere, a recess, a rib, a polygonal cone, a round cylinder or a sawtooth.

The template mold severing screw bar 2 further includes a coupling head 5 which includes a coupling portion 51 to couple on the transmission end 32 and an activation portion 52 at one end opposite to the coupling portion 51. The activation portion 52 is connected to a power machine (not shown in the drawings) to transmit power. Through the elements and structure set forth above the template mold severing screw bar 2 is formed.

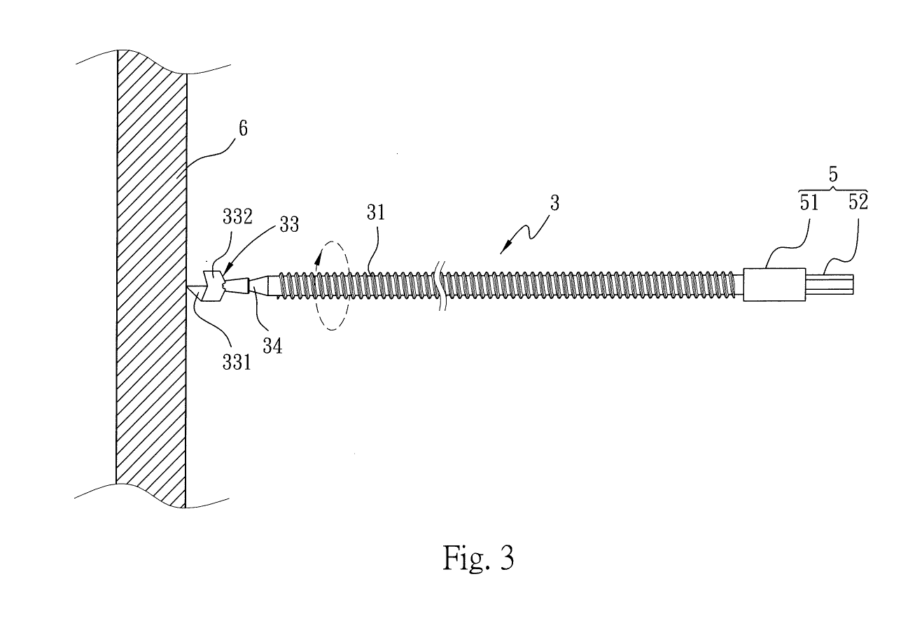

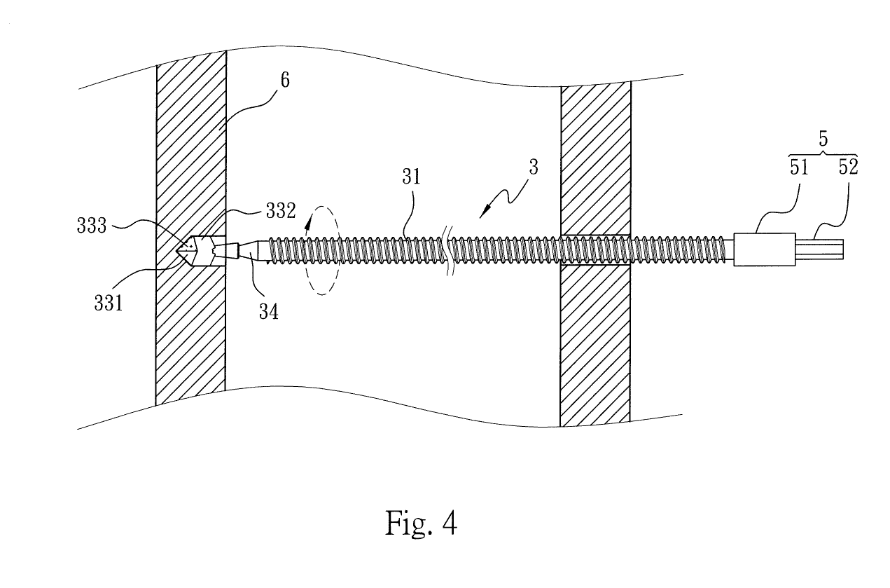

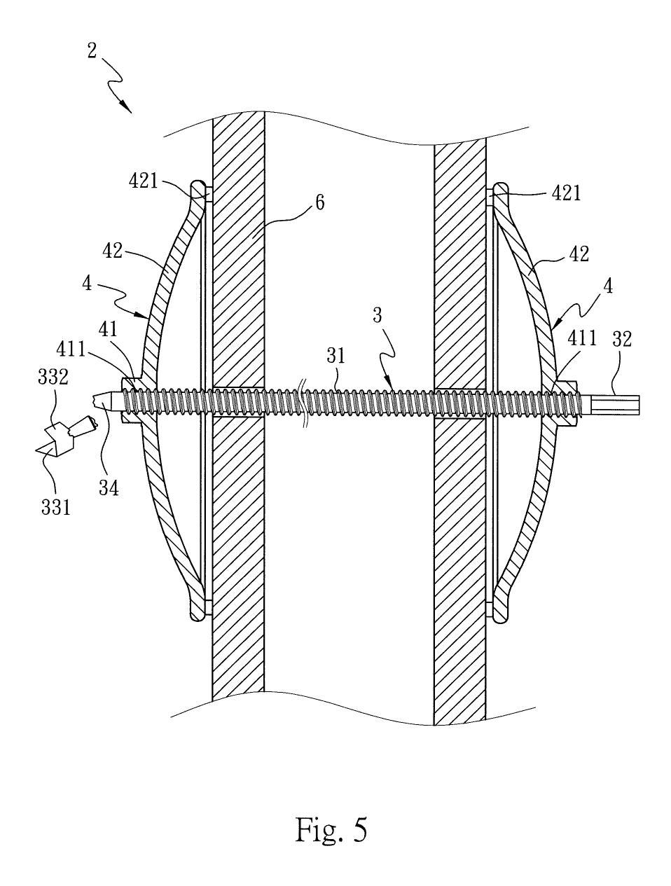

Please referring to FIGS. 2 through 5, when the template mold severing screw bar 2 of the invention is in use, in one embodiment, on the intended template mold construction site, the activation portion 52 of the coupling head 5 is coupled with the power machine while the coupling portion 51 at another end is coupled on the transmission end 32 of the self-tapping screw bar 3. In another embodiment the transmission end 32 can be directly coupled with the power machine to transmit power. In this embodiment the transmission end 32 is, but not limited to, a hexagonal strut. The power machine directly drives the self-tapping screw bar 3 spinning through the coupling head 5, and through the edge portion 331 of the tapping end 33, proceeds drilling operation on the two opposing templates 6. When the tapping end 33 cuts into the two templates 6, as the diameter of the tapping end 33 is greater than that of the thread portion 31, the thread portion 31 can easily pass through the two templates 6. The shred exit portion 332 also provides a shred exit space 333. The shreds being generated gradually accumulate in the shred exit portion 332. When the self-tapping screw bar 3 continuously taps into the two templates 6 the shreds accumulate in the stem shrunk portion 34 and are discharged from the drilling holes, therefore the shreds can be prevented from accumulating in the drilling holes to hinder the tapping end 33 and reduce drilling resistance, thus the edge portion 331 can easily cut through the templates 6 to do drilling operation.

After the self-tapping screw bar 3 has run through the templates 6, couple the anchor member 4 on the edge portion 331 of the self-tapping screw bar 3 to hold the edge portion 331 in the trench 412; then control the anchor member 4 to move the screw hole 411 to directly pass through the edge portion 331, and screw the screw hole 411 of the anchor member 4 on the thread portion 31 with the leaning portion 42 leaned tightly on one end of each template 6 so that the friction end 421 leans on the template 6. In this embodiment the friction end 421 includes at least one sawtooth, but can also be at least one semi sphere, one sphere, one recess, one rib, one polygonal cone, one round cylinder or the like in other embodiments, so that the two templates 6 can be screwed together to provide enhanced friction force to withstand great pressure during concrete filling operation and prevent dislocation to avoid other problems from taking place. Finally, screw another anchor member 4 on another end of the self-tapping screw bar 3 at the opposite position in the opposite direction. In addition, the tapping end 33 can be removed through the stem shrunk portion 34 via a tool after the self-tapping screw bar 3 has finished drilling to avoid causing injury to people at the construction site. As a result, the self-tapping screw bar 3 can be positioned between the two templates 6 to facilitate concrete filling operation later. During construction, in the event that the templates 6 cannot withstand the transverse pressure of the concrete filling operation and the risk of collapse of the templates 6 arises, a temporary reinforced structure can be erected quickly through the anchor members 4 to prevent construction suspension from taking place.

As a conclusion, compared with the convention technique, the invention provides the self-tapping screw bar 3 to run through the two templates 6 and the two anchor members 4 that are screwed on two ends of the self-tapping screw bar 3 in a mirror image fashion to hold the templates 6 between the two anchor members 4, thus can save a lot of construction processes and greatly improve usability for total construction work.

What is claimed is:

1. A template mold severing screw bar used on template construction work, comprising:
a self-tapping screw bar including a thread portion formed annularly on the circumference thereof, a transmission end and a tapping end at another end opposite to the transmission end; and
at least one anchor member which is screwed on the thread portion and includes a screwing portion and a leaning portion anchored on one end of the screwing portion; the screwing portion including a screw hole screwed by the thread portion, the leaning portion including an aperture communicating with the screw hole.

2. The template mold severing screw bar according to claim 1, wherein the tapping end includes an edge portion and a shred exit portion, and wherein the edge portion is located at lateral sides of the tapping end, and the shred exit portion is located at one side abutting to the edge portion.

3. The template mold severing screw bar according to claim 1, wherein the transmission end is a polygonal strut.

4. The template mold severing screw bar according to claim 3, wherein the polygonal strut is a triangular strut, a quadrangle strut, a pentagonal strut, a hexagonal strut, a heptagonal strut, an octagonal strut, a nonagonal strut or a decagonal strut.

5. The template mold severing screw bar according to claim 1, wherein the self-tapping screw bar further includes a stem shrunk portion between the tapping end and the thread portion.

6. The template mold severing screw bar according to claim 1, wherein the tapping end is formed at a diameter greater than that of the thread portion.

7. The template mold severing screw bar according to claim 1, wherein the screw hole further includes at least one trench running through an end surface of one side of the anchor member and an end surface of another side thereof, or running through by incorporating with the tapping end.

8. The template mold severing screw bar according to claim 1, wherein the leaning portion is formed in a non-plane fashion, and includes a friction end at one end remote from the screwing portion.

9. The template mold severing screw bar according to claim 1, wherein the friction end is formed in at least a semi-sphere, a sphere, a recess, a rib, a polygonal cone, a round cylinder, or a sawtooth.

10. The template mold severing screw bar according to claim 1, wherein the template mold severing screw bar further includes a coupling head which includes a coupling portion to couple on the transmission end and an activation portion at one end opposite to the coupling portion, and wherein the activation portion is connected to a power machine to transmit power.
